(19) United States
(12) Patent Application Publication
(10) Pub. No.: US 2002/0082861 A1
(43) Pub. Date: Jun. 27, 2002

(54) Device setting support system

(76) Inventor: Shuichi Takata, Tokyo (JP)

Correspondence Address: McGinn & Gibb, PLLC, 8321 Old Courthouse Road, Suite 200, Vienna, VA, 22182-3817, US

(21) Appl. No.: 10/023,739

(22) Filed: Dec. 21, 2001

(30) Foreign Application Priority Data
Dec. 22, 2000 (JP) 390811/2000

(51) Int. Cl. G06F 17/60

(52) U.S. Cl. 705/1

(57) ABSTRACT

A device setting support system includes an information device, a service center terminal, a customer center terminal, and a retail store terminal. When a user purchases the information device at a retail store, the retail store terminal sends customer information and device information to the customer center terminal. After that, when the user sets up the information device, data identifying the information device are sent to the customer center terminal. Then, in the customer center terminal, customer information and device information corresponding to the information device are determined and sent to the service center terminal. The service center terminal sends the received information with advertisement information to the information device. The information device then performs device setting of its own by using the information.

### BACKGROUND OF THE INVENTION

1. Field of the Invention

The invention relates to a system for supporting a device setting to make an information device OF a user available, in particular, to a support system which performs a device setting of a device based on customer information supplied from a user when the user purchases the device and device information, from a service institution located in a remote site.

2. Description of the Related Art A device setting is always required to use an information device purchased by a user. When the user performs the device setting, the user is required to register customer information of the user to a service institution. The registration is required even if the customer information of the user has been already registered to the service institution.

For example, in a device setting of an information devise for connecting to the Internet or using an electronic mail (E-mail), when a user turns on the information device after confirming a connection between the information device and a modular jack (which is a connector to connect a device such as a telephone located at a home to a telephone network), a guidance screen for setup of a network connection is displayed, and the information device is restarted and the setup of the network connection is completed with being connected to the Internet by clicking according to designations shown in the guidance screen.

Then, another guidance screen for sign-up is displayed. To complete the sign-up, the user enters an address, a name, a phone number, a payment method, ID, password, and other customer information of the user by clicking a mouse or typing a keyboard. Consequently, the information device can be connected to the Internet and use resources connected to the Internet.

Items of the customer information which is entered in the sign-up are coincident with items of customer information obtained form a user who purchases an information device at a retail store.

Also, a user of an information device sometimes is in trouble with operations of the setup and the sign-up, because a long time have not past since purchasing of the information device and therefore the user does not master a use of the information device. It is possible to support the user's operations of the setup and the sign-up from a service center (service institution) by using customer information of the user and device information of the information device.

Further, there is a problem of provision of revision information to an information device or an application software to support a device setting of a beginner. It is possible to provide the revision information from the service center by also using the customer information and the device information.

Still further, when the user accept the support from the service center, a connection charge for connecting between the information device and the service center and a supporting charge for a device setting will occur.

The user can reduce or take over the cost by accepting advertisement information.

### SUMMARY OF THE INVENTION

In a device setting for a beginner who does not master a use of an information device, it is required to perform device setting operation such as a setup operation or a sign-up operation, and provision (entering) of revision information for the information device and a software.

To perform the device setting operations and the provision of revision information by a service center, device information and customer information are used. The customer information is composed of information which is supplied from a user of an information device when the user purchases the information device at the retail store.

The reason is that information required to perform the device setting is included in the customer information and the device information, and the information device and the software requiring the revision information are included in the device information.

Further, advertisement information is provided to the information device so that the user does not bear a supporting cost accrued in the service center. Thereby, the user can easily accept the support since the supporting cost is not charged.

Therefore, it is an object of the invention to provide a device setting support system which performs, at an outside of a service center, a device setting of an information device by using customer information which is supplied from a user when the user purchases the information device and device information.

It is another object of the invention to provide a device setting support system which does not charge to a user a supporting cost of a service center, by providing advertisement information to the user (information device).

According to a first aspect of the invention, there is provided a device setting support system which supports device setting of an information device purchased by a user. The system comprises a database which stores customer information of the user and device information representing a configuration of the information device and a service center terminal which sends device setting information including the customer information and the device information to the information device, wherein the information device receives the device setting information from the service center terminal and performs the device setting of its own based on the device setting information.

According to a second aspect of the invention, there is provided a device setting support system which supports device setting. The system comprises (1) a retail store terminal which is located in a retail store and sends customer information identifying the user, device information identifying the information device, and authentication information used to authenticate the user, to a customer center terminal located at a customer center when the user purchases the information device at the retail store, (2) an information device which is objective of the device setting and sends device related data identifying the information device and the authentication information entered by the user to the customer center terminal when the information device is started at the user's site, (3) a customer center terminal collates the device information in the database with the received device related data and retrieves the device information and the customer information corresponding to the information device that the device setting is to be performed, and (4) a service center terminal which is located at a service center arranged in a site different from a site where the information device is located and sends the received device information, the received customer information, and advertisement information to the information device. Wherein the information device performs the device setting based on the received device information and the received customer information, with displaying the received advertisement information.

According to a third aspect of the invention, the service center terminal sends advertisement information to the information device in the first aspect of the invention.

According to a fourth aspect of the invention, the information device displays the received advertisement information in parallel with the performing of the device setting in the third aspect of the invention.

According to a fifth aspect of the invention, the device setting information comprises the customer information including one of an address of the user, a name of the user, and a telephone number of the user, and the device information including an identifier of the information device in the first aspect of the invention.

According to a sixth aspect of the invention, the device setting information comprises revision information about a revision of a software operating in the information device in the fifth aspect of the invention.

According to a seventh aspect of the invention, there is provided a method of supporting a device setting of an information device purchased by a user in a device setting support system. The method comprises the steps of storing, at a retail store terminal located in a retail store, customer information identifying the user and device information identifying the information device to a database when the user purchases the information device at the retail store, and performing, at the information device, the device setting of its own based on the customer information and the device information.

According to an eighth aspect of the invention, there is provided a recording medium readable by a computer, tangibly embodying a program of instructions executable by the computer to perform a method of supporting a device setting of an information device purchased by a user in a device setting support system, comprising the steps of storing, at a retail store terminal located in a retail store, customer information identifying the user and device information identifying the information device to a database when the user purchases the information device at the retail store, and performing, at the information device, the device setting of its own based on the customer information and the device information.

According to a ninth aspect of the invention, there is provided a computer data signal embodied in a carrier wave and representing a sequence of instructions which, when executed by a processor, cause the processor to perform a method of supporting a device setting of an information device purchased by a user in a device setting support system, comprising the steps of storing, at a retail store terminal located in a retail store, customer information identifying the user and device information identifying the information device to a database when the user purchases the information device at the retail store, and performing, at the information device, the device setting of its own based on the customer information and the device information.

According to a tenth aspect of the invention, there is provided a program product comprising, computer readable instructions and a recording medium bearing the computer readable instructions, the instructions being adaptable to enable a computer to perform a method of supporting a device setting of an information device purchased by a user in a device setting support system, comprising the steps of storing, at a retail store terminal located in a retail store, customer information identifying the user and device information identifying the information device to a database when the user purchases the information device at the retail store, and performing, at the information device, the device setting of its own based on the customer information and the device information.

### BRIEF DESCRIPTION OF THE DRAWINGS

FIG. 1 shows a diagram representing a network structure of a device setting support system according to an embodiment of the invention;

FIG. 2 shows a block diagram of a configuration of an information device shown in FIG. 1;

FIG. 3 shows a diagram representing a configuration of a service center terminal shown in FIG. 1;

FIG. 4 shows a diagram representing a configuration of a retail store terminal shown in FIG. 1;

FIG. 5 shows a diagram representing a configuration of a customer center terminal shown in FIG. 1; and

FIG. 6 shows a flowchart of an operation to support a device setting in the embodiment of the invention.

### DESCRIPTION OF THE PREFERRED EMBODIMENT

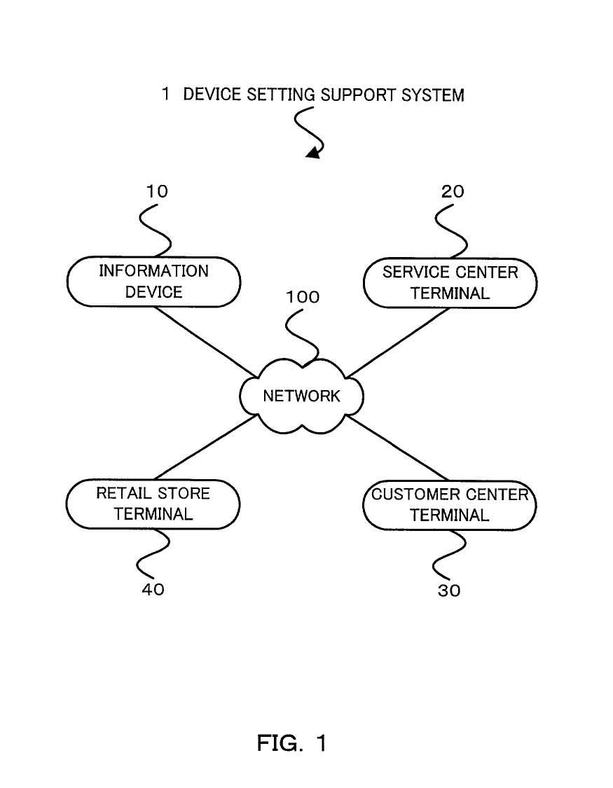

First, description is made about a device setting support system according to an embodiment of the invention with reference to FIGS. 1-5.

Referring to FIG. 1, the device setting support system 1 includes an information device 10 which is purchased by a user and is an objective of a device setting, a service center terminal 20 which is located at a service center, a customer center terminal 30 which collects customer information of users and device information and manages a customer database, a retail store terminal 40 which is located at a retail store in which users purchase information devices, and a network 100.

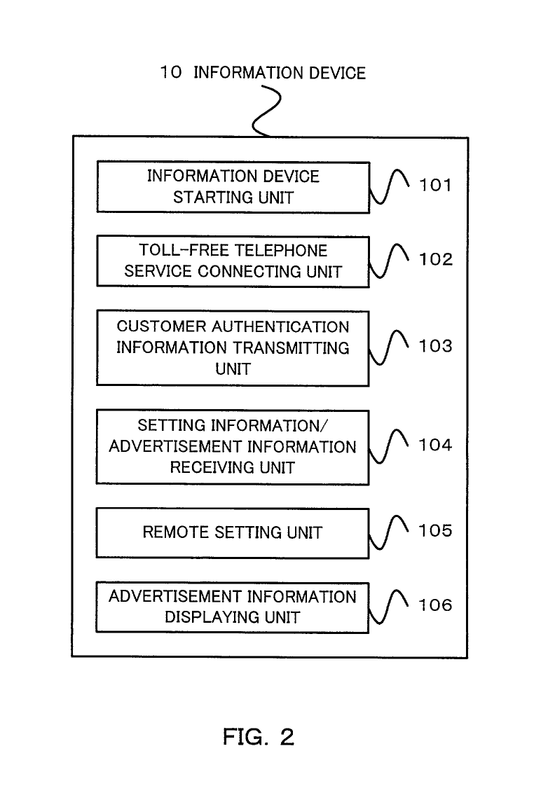

Then, referring to FIG. 2, the information device 10 includes an information device starting unit 101, a toll-free telephone service connecting unit 102, a customer authentication information transmitting unit 103, a setting information/advertisement information receiving unit 104, a remote setting unit 105, and an advertisement information displaying unit 106.

The information device starting unit 101 automatically starts operations when the information device is turned on. The toll-free telephone service connecting unit 102 automatically connects the information device 10 to the service center terminal 20 if the information device 10 is connected to a telephone line.

The customer authentication information transmitting unit 103 transmits authentication information of the user to the service center terminal 20. And the setting information/advertisement information receiving unit 104 receives device setting information and advertisement information sent from the service center terminal 20.

The remote setting unit 105 performs device setting according to a designation from the service center terminal 20. The advertisement information displaying unit 106 displays the advertisement information.

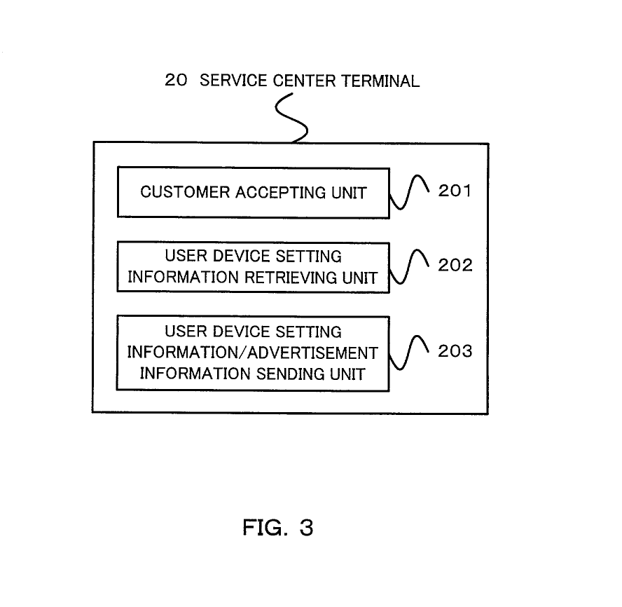

Next, as shown in FIG. 3, the service center terminal 20 includes a customer accepting unit 201, a user device setting information retrieving unit 202, and a user device setting information/advertisement information sending unit 203.

The customer accepting unit 201 is connected to the information device 10 via the toll-free telephone service. The user device setting information retrieving unit 202 retrieves from the customer center terminal 30, device setting information which is used in a device setting of an information device 10 authorized by the authentication information of a user.

And the user device setting information/advertisement information sending unit 203 sends the device setting information and the advertisement information to the information device 10 of the user.

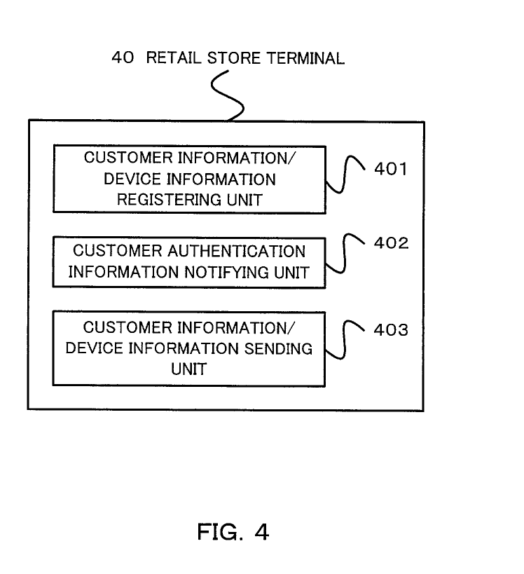

Referring to FIG. 4, the retail store terminal 40 includes a customer information/device information registering unit 401, a customer authentication information notifying unit 402, and a customer information/device information sending unit 403.

The customer information/device information registering unit 401 registers customer information of a user and device information of an information device 10 which is purchased by the user. The customer authentication information notifying unit 402 notifies the user of authentication information of the user.

The customer information/device information sending unit 403 sends the customer information and the device information to the customer center terminal 30.

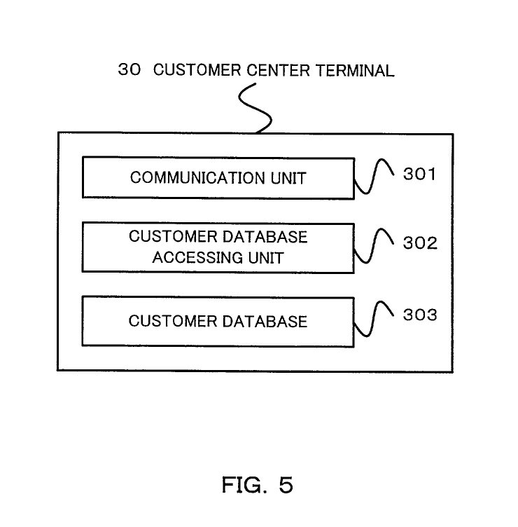

Then, as shown in FIG. 5, the customer center terminal 30 includes a customer database 303, a customer database accessing unit 302, and a communication unit 301.

The customer database 303 includes and manages customer information, customer authentication information, and the device information.

The customer database accessing unit 302 accesses the customer database 303 and the communication unit 301 sends database information to the retail store terminal 40 and the service center terminal 20.

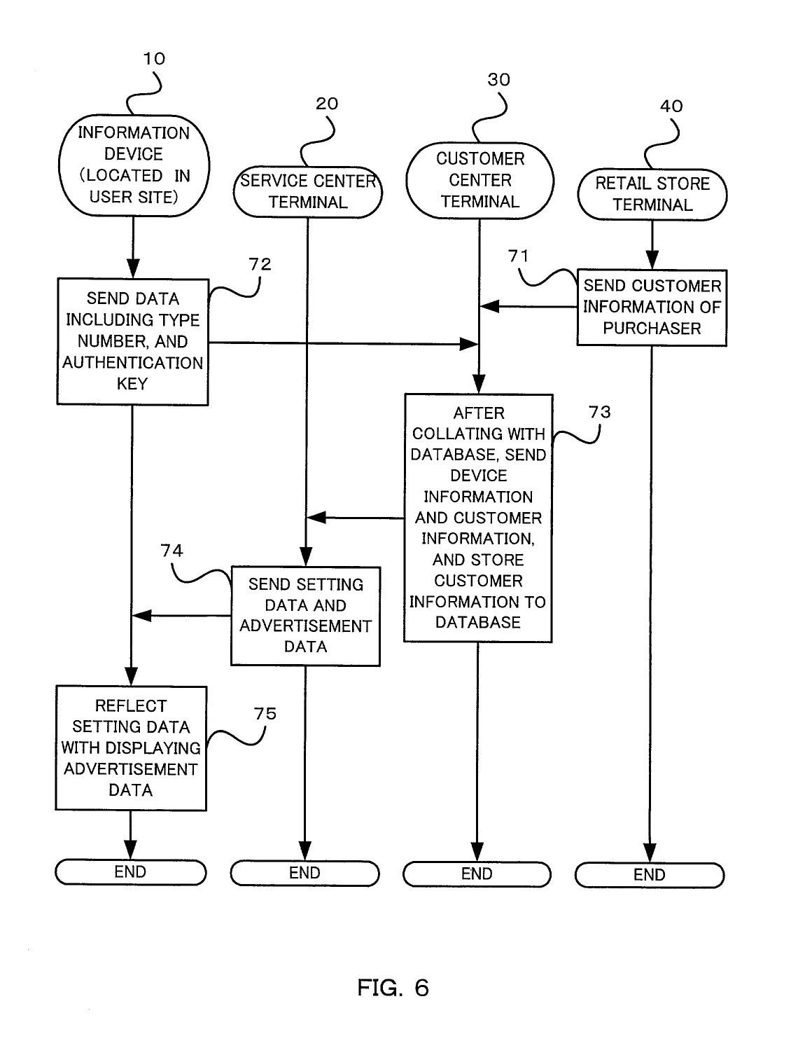

Next, description is made about operations of supporting of a device setting according to the embodiment of the invention mainly referring to FIG. 6.

Also, hereinafter, it is assumed that the network 100 is the Internet, and the information device 10 is a personal computer.

In the customer database 303 of the customer center terminal 30 shown in FIG. 6, the customer information which is registered from the customer information/device information registering unit 401 of the retail store terminal 40, device information, and authentication information of a user are stored and managed (step 71 in FIG. 6).

When the information device 10 purchased by the user is firstly turned on after being purchased or an operation to initialize a device setting, the information device starting unit 101 and the toll-free telephone service connecting unit 102 are started to operate, and the information device 10 is automatically connected to the communication unit 301 (or the customer accepting unit 201) of the customer center terminal 30 via the network 100 and the toll-free telephone service.

At this time, the information device 10 sends data including a type number of the device or the like which are recorded before being purchased, and data of an authentication key supplied by the user, to the customer center terminal 30 by using the customer authentication information sending unit 103 (step 72).

Then, the customer center terminal 30 searches the customer database 303 via the customer database accessing unit 302 by using the authentication key (information) of the user. And the terminal 30 determines the information device which is purchased by the user, based on the customer information of the user and the device information. Then, the terminal 30 obtains device information corresponding to the determined information device based on a product name, a type number, or the like of the information device, and sends the obtained device information and the customer information to the service center terminal 20 via the communication unit 301 (step 73). Further, the customer center terminal 30 registers, to the customer database 303, the customer information which is entered from the information device 10 when the user performs a sign-up operation or the like (step 72).

The service center terminal 20 sends device setting information of a user's information device 10 and proper advertisement information based on customer information of the user to the information device 10. The information device 10 receives them by using the setting information/advertisement information receiving unit 104 (step 74).

The information device 10 performs a device setting for its own by using the remote setting unit 105 and the received device setting information. While the information device 10 performs the device setting, the advertisement information displaying unit 106 displays the advertisement information (step 75).

Next, it is clear that the embodiment of the invention can be applied to a system which automatically performs an improvement of a device when the device is shipped, and a revision of the device, via a network 100. That is, the embodiment can be applied to the system by providing device setting information sent from the service center terminal 20 as revision information of a software.

Further, when the information device 10 is sold as a device having a standard configuration, it is clear that a user can customize the information device 10 by using device setting information after the user locates the information device 10.

Additionally, when the information device 10 is a television set, a video recorder, or the like other than a personal computer, it is clear that the embodiment of the invention can be applied to a system which automatically performs different tuning operations for each area at the service center terminal 20 via a network 100.

Therefore, it is a first effect of the invention to support a device setting of an information device for a beginner via a network. According to the invention, a device setting for a setup operation and a sign-up operation is performed by the service center terminal on the basis of device information and customer information which is supplied by a user when the user purchases the information device.

It is a second effect of the invention to perform a revision of a software without increasing a complexity of user's operations, even if a manufacturer makes a plurality of products having the same hardware structure. According to the invention, if it would be possible to resolve a problem of a device occurs in a shipment stage by replacing a software, an information device can receive device setting information including revision information for the software from the service center terminal when the user actually performs a device setting.

It is a third effect of the invention to perform device setting, or a revision of a software and an improvement of a function after shipment without bearing a part of or all of a communication cost. According to the invention, advertisement information is provided to an information device in performing the device setting or the like, thereby the part of or all of the communication cost is took over.

It is a fourth effect of the invention to customize based on an own use plan without increasing a complexity of operations of a user who purchases an information device of a standard structure, by sending device setting information from the service center. According to the invention, device setting information is supplied by the service center terminal based on device information and customer information supplied from the user when the user purchases the information device.

It is a fifth effect of the invention to pay a service cost by obtaining a source of an advertisement income. According to the invention, a manufacturer can obtain a new income source by supplying advertisement information to a user of an information device.

Each element of the device setting support system 1 can be a personal computer including a CPU, a memory, a storage device, and a network interface. Therefore, to realize the system of the invention, a program can be loaded into the memory of each computer and the CPU works based on instructions in the program loaded in the memory.

Such the program is usually provided in a forma of a floppy disk, a CD-ROM, a DVD-ROM, or other types of storage mediums. However, via the network interface and a network such as the Internet, the program can be provided to the memory of each computer.

Thus, the information device 10, the service center terminal 20, the customer center terminal 30, and the retail store terminal 40 are controlled by the program and, as a whole, form the system of the invention. The program can be supplied for each element (computer), or as a single program.

What is claimed is:

1. A device setting support system which supports device setting of an information device purchased by a user, comprising:
a database which stores customer information of the user and device information representing a configuration of the information device, the customer information and the device information being registered to the database when the information device is purchased by the user; and
a service center terminal which sends device setting information including the customer information and the device information to the information device, wherein the information device receives the device setting information from the service center terminal and performs the device setting of its own based on the device setting information.

2. The device setting support system of claim 1, wherein the service center terminal is located at a service center and the service center is arranged in a site different from a site where the information device is located.

3. The device setting support system of claim 2, wherein the service center terminal comprises:
a customer accepting unit which connects to the information device via a toll-free telephone service when the information device is started.

4. The device setting support system of claim 3, wherein the service center terminal further comprises:
an information retrieving unit which retrieves the device setting information from the database by using authentication information corresponding to the user as a key.

5. The device setting support system of claim 4 further comprising:
a customer center terminal which is located at a customer center, wherein the customer center includes the database and the database further includes the authentication information.

6. The device setting support system of claim 5 further comprising:
a retail store terminal which is located at a retail store where the information device is purchased by the user, wherein the retail store terminal obtains the device setting information and notifies the user of the authentication information, and sends the device setting information and the authentication information to the database in the customer center terminal.

7. The device setting support system of claim 1, wherein the service center terminal sends advertisement information to the information device.

8. The device setting support system of claim 7, wherein the information device displays the received advertisement information in parallel with the performing of the device setting.

9. The device setting support system of claim 1, wherein the device setting information comprises the customer information including one of an address of the user, a name of the user, and a telephone number of the user, and the device information including an identifier of the information device.

10. The device setting support system of claim 9, wherein the device setting information comprises revision information about a revision of a software operating in the information device.

11. A device setting support system which supports device setting, comprising:
a retail store terminal which is located in a retail store and sends customer information identifying the user, device information identifying the information device, and authentication information used to authenticate the user, to a customer center terminal located at a customer center when the user purchases the information device at the retail store;
an information device which is objective of the device setting and sends device related data identifying the information device and the authentication information entered by the user to the customer center terminal when the information device is started at the user's site;
a customer center terminal collates the device information in the database with the received device related data and retrieves the device information and the customer information corresponding to the information device that the device setting is to be performed; and
a service center terminal which is located at a service center arranged in a site different from a site where the information device is located and sends the received device information, the received customer information, and advertisement information to the information device, wherein the information device performs the device setting based on the received device information and the received customer information, with displaying the received advertisement information.

12. A method of supporting a device setting of an information device purchased by a user in a device setting support system, comprising the steps of:
storing, at a retail store terminal located in a retail store, customer information identifying the user and device information identifying the information device to a database when the user purchases the information device at the retail store; and
performing, at the information device, the device setting of its own based on the customer information and the device information.

13. A method of supporting a device setting of an information device purchased by a user in a device setting support system, comprising the steps of:
sending, at a retail store terminal located in a retail store, customer information identifying the user, device information identifying the information device, and authentication information used to authenticate the user, to a customer center terminal located at a customer center when the user purchases the information device at the retail store;
sending, at the information device, device related data identifying the information device and the authentication information entered by the user to the customer center terminal when the information device is started at the user's site;
collating, at a customer center terminal, the device information in the database with the received device related data, and retrieving the device information and the customer information corresponding to the information device that the device setting is to be performed;
sending, at a service center terminal which is located at a service center arranged in a site different from a site where the information device is located, the received device information, the received customer information, and advertisement information to the information device; and
performing, at the information device, the device setting based on the received device information and the received customer information, with displaying the received advertisement information.

14. A recording medium readable by a computer, tangibly embodying a program of instructions executable by the computer to perform a method of supporting a device setting of an information device purchased by a user in a device setting support system, comprising the steps of:
storing, at a retail store terminal located in a retail store, customer information identifying the user and device information identifying the information device to a database when the user purchases the information device at the retail store; and
performing, at the information device, the device setting of its own based on the customer information and the device information.

15. A computer data signal embodied in a carrier wave and representing a sequence of instructions which, when executed by a processor, cause the processor to perform a method of supporting a device setting of an information device purchased by a user in a device setting support system, comprising the steps of:
storing, at a retail store terminal located in a retail store, customer information identifying the user and device information identifying the information device to a database when the user purchases the information device at the retail store; and
performing, at the information device, the device setting of its own based on the customer information and the device information.

16. A program product comprising, computer readable instructions and a recording medium bearing the computer readable instructions, the instructions being adaptable to enable a computer to perform a method of supporting a device setting of an information device purchased by a user in a device setting support system, comprising the steps of:
storing, at a retail store terminal located in a retail store, customer information identifying the user and device information identifying the information device to a database when the user purchases the information device at the retail store; and
performing, at the information device, the device setting of its own based on the customer information and the device information.
